(19) United States
(12) Patent Application Publication
(10) Pub. No.: US 2023/0268816 A1
(43) Pub. Date: Aug. 24, 2023

(54) ENERGY EFFICIENT, MOVING COIL OR MOVING MAGNET, DUAL POSITION LATCHING SOLENOID FOR LATCHING AND LINEAR MOTOR APPLICATIONS, AND APPARATUSES USING THE SAME

(71) Applicant: Glen A. Robertson, Madison, AL (US)

(72) Inventor: Glen A. Robertson, Madison, AL (US)

(21) Appl. No.: 17/676,146

(22) Filed: Feb. 19, 2022

(51) Int. Cl. H02K 41/03; H02K 7/14

(52) U.S. Cl. CPC H02K 41/031; H02K 7/14

(57) ABSTRACT

The present invention is directed toward providing a new embodiment of prior art Dual Position Latching Solenoid (DPLS), that allows for a moving coil section or moving permanent magnet section, with increased magnetic attraction force and increased travel distance. In this new DPLS embodiment, the control coil and the permanent magnet are separated, which allows magnetic attraction for latching and repulsion for unlatching. Further, this allows the DPLS to be used as Dual Poled Linear Motor (DPLM) that is less dependent on the control coil size as in some prior art linear motors, by using the linear magnetic attraction and repulsion for increase magnetic force, and by using multiple parallel coils to reduce the control coil's resistance. Like prior art DPLS, the permanent magnet section is composed of a toroidal permanent magnet within an inner and outer magnetic core, to produce dual magnetic poles. The coil section(s) is much identical to the permanent magnet section with the toroidal permanent magnet replaced with the control coil. In the preferred embodiment, the outward pole side of the coil section has the attractor used in prior art DPLS embodiments attached to the outward pole sides of the inner and outer magnetic core to encapsulate (on three sides) the control coil and the magnetic flux from the permanent magnet section and the magnetic flux created by the control coil when activated (carrying a current). Then by placing a coil section on one or both sides of the permanent magnet section, the section(s) can be placed in magnetic attraction or repulsion, when the control coil is activated.

### BACKGROUND OF THE INVENTION

### 1. Field of the Invention

This invention relates generally to the field of energy efficient, Dual Position Latching Solenoids (DPLS), except that the permanent magnet is separated from the control coil(s) to produce a coil section and a permanent magnet section, which produces increased magnetic force and movement distance, and allows high oscillation of the coil section or permanent magnetic, so that the DPLS can be used as a linear motor, called the Dual Poled Linear Motor (DPLM). As with some DPLS embodiments, by adding springs that works in concert with the magnetic attraction force, the energy efficiency and operability can be further increase. Further, due to the separation of the control coil from the permanent magnet, magnetic repulsion can be used to enhance motion.

### 2. Description of Prior Art DPLS

In U.S. Pat. No. 9,702,477 (FIGS. 3), and U.S. Pat. No. 10,024,453 (FIG. 3), the DPLS contains a central portion having a dual poled, radially poled permanent magnet, with two adjacent control coils, one on either side, operated by a pulse current means for energy efficiency, to direct the magnetic flux from the permanent magnet in either of two directions, to alternately attract or release two magnetic pole ends for use in various alternating latching applications.

In U.S. Pat. No. 10,508,481 (FIG. 3), the DPLS contains a central portion having a dual poled, radially poled permanent magnet, with one adjacent control coil, operated by a pulse current means for energy efficiency, to direct the magnetic flux from the permanent magnet in either of two directions, to attract or release a single magnetic pole end for use in various latching applications.

### 3. Description of the DPLM

While the use of linear motors are well known, no such linear motor is known to exist using the Dual Position Latching Solenoid (DPLS) technology developed by the present inventor as a base, especially related to the DPLS embodiment as presented in U.S. Pat. Nos. 9,702,477, 10,024,453, and 10,508,481.

The present invention separates the permanent magnet from the control coil to produce a coil section and a permanent magnet section. Whereby, when used as a linear motor, either the permanent magnet section can be fixed with respect to the coil section, inferred to as a moving coil linear motor, or the coil section can be fixed with respect to the permanent magnet section, inferred to as a moving magnet linear motor. Further, springs are needed to prevent the two sections from magnetically latching during operation, which also helps to provide a more sinusoidal motion of the moving section. Where when, the moving section and springs are attached to a piston in a housing, and the control coil(s) is sent an oscillating impulse current, the moving section and springs oscillate in a sinusoidal fashion to produce compression or pumping on a gas or fluid.

A pump typically has valves to control the input and outlet of the gas or fluid to a piston, whereas a compressor may not have any valves. In the following, only prior art pulse tube cryocooler linear motor examples are discussed, to provide more clarity toward the present invention. Noting that the compressor in pulse tube cryocoolers are typically pulse wave generators, having no valves.

### 4. Prior Art Moving Coil Linear Motors

State-of-art moving coil linear motors with permanent magnets are used in a variety of devices. Examples are the moving coil linear motors used in fluid or gas compressors or pumps. One compressor example are those used in cryocoolers, for example, in U.S. Pat. No. 5,488,830, “Orifice Pulse Tube with reservoir within Compressor,” by Burt, Feb. 6, 1996; as discussed in the paper “Pulse Tube Cryocoolers for Cooling Infrared Sensors,” by Radebaugh, in the Proceedings of SPIE, The International Society for Optical Engineering, Infrared Technology and Applications XXVI, Vol. 4130, pp. 363-379 (2000); or as discussed in the paper “High Speed Compressors,” by Bailey, Dadd, and Stone, Cryocoolers 17, edited by S. D. Miller and R. G. Ross, Jr., International Cryocooler Conference, Inc., Boulder, Colo., pp. 347-356, (2012).

The moving coil linear motors in these cryocooler compressors use an open control coil that moves perpendicular to the magnetic field created across the north/south pole in a gap between the magnetic materials placed on the poles of a permanent magnet. The perpendicular movement is oscillatory caused by the oscillating magnetic field in the control coil, created by an applied AC current. The oscillation of the control coil is caused by the magnetic field in the control coil being attracted or repelled by the magnetic field from the permanent magnet in the gap. The control coil is attached to one or more (flexure) springs and attached a piston in a housing, pulling/pushing them to produce compression on a gas.

### 5. Prior Art Moving Magnet Linear Motor

Examples of a moving magnet linear motor can be found in “Design, Development and Testing of Moving Magnet Linear Motor Compressor,” by Awargand, Khot, and More, International Journal of Science and Research, Volume 7 Issue 3, March 2018; and “Linear Cryogenic Coolers for Hot Infrared Detectors,” by Veprik, et. al., International Cryocooler Conference, Cryocoolers 17, edited by S. D. Miller and R. G. Ross, Jr.

The moving magnet linear motor in these cryocooler compressors use a fixed magnetic material or core about a fixed control coil. The fixed magnetic core is split on one side of the control coil to produce a gap. The gap produces two poles on the magnetic core, one on either side of the control coil. Such that when the control is carrying a current, the direction of the magnetic flux in one gap is reversed from the direction of the magnetic flux in the other. A cylindrical and radially pole permanent magnet is placed in the gap between the poles. The application of an AC current to the control coil, then cause the permanent magnet to be attracted by one pole of the magnetic core, while being repelled by the other pole, in an oscillatory fashion. The permanent magnet is attached to one or more (flexure) springs and attached to a piston in a housing, pulling/pushing them to produce compression on a gas.

### 6. What is Needed

In state-of-art moving coil or moving magnet linear motors, especially for cryocooler compressors as discussed herein, the driving magnetic force is related to the control coil area and the current applied to the control coil with respect to the magnetic field strength of the permanent magnet. Whereby, the size, weight and input power of moving coil or magnetic linear motors are driven by the control coil. Further, the movement in the magnetic field in both the moving coil or moving magnet linear motors cryocooler compressors (discussed herein) are a sliding actions in a magnetic field rather than linear pole attraction. It can be shown that the magnetic force in sliding action devices can be much less than the linear attractive force between magnetic poles, as used in the present invention. This is due to the fact that magnetic field gets stronger close to the poles of a permanent magnet or magnetic core, when linearly magnetically attracted. Whereas, the coil in sliding action devices are sliding toward a fixed magnetic field across a gap.

Therefore, what is needed, is a moving coil or moving magnet linear motor that is not as dependent on the control coil as in prior art, and using the attractive force between magnetic poles to increase the magnetic force; both adding to increase efficiency in a smaller size.

### SUMMARY OF THE INVENTION

The present invention is directed toward providing a new embodiment of prior art Dual Position Latching Solenoid (DPLS), that allows for a moving coil section or moving permanent magnet section, with increased magnetic attraction force and increased travel distance. In this new DPLS embodiment, the control coil and the permanent magnet are separated, which allows magnetic attraction for latching and repulsion for unlatching. Further, this allows the DPLS to be used as Dual Poled Linear Motor (DPLM) that is less dependent on the control coil size as in prior art linear motors, by using the linear magnetic attraction and repulsion for increase magnetic force, and by using multiple parallel coils to reduce the control coil's resistance.

The moving coil or moving magnet, DPLS or DPLM, is based on the Dual Position Latching Solenoid (DPLS) developed by the present inventor, having the coil and permanent magnet separated into a coil section and a permanent magnet section, and using multiple parallel coils to reduce the control coil's resistance, as discussed in “Energy Efficient Bi-Stable Permanent Magnet Actuation System,” U.S. Pat. No. 9,343,216, May 17, 2016, by the present inventor.

Like with prior art DPLS, the permanent magnet section is composed of a toroidal permanent magnet within an inner and outer magnetic core, to produce dual magnetic poles. The coil section(s) is much identical to the permanent magnet section with the toroidal permanent magnet replaced with the control coil. In the preferred embodiment, the outward pole side of the coil section has the attractor used in prior art DPLS embodiments attached to the outward pole sides of the inner and outer magnetic core to encapsulate (on three sides) the control coil and the magnetic flux from the permanent magnet section and the magnetic flux created by the control coil when activated (carrying a current). Then by placing a coil section on one or both sides of the permanent magnet section, the section(s) can be placed in magnetic attraction or repulsion, when the control coil is activated.

The DPLS and DPLM use the “Energy Efficient Bi-Stable Permanent Magnet Actuation System,” U.S. Pat. No. 9,343,216, May 17, 2016, by the present inventor, as the controller, with respect to using one or two control coils.

When used for the DPLM, the controller provides high frequency impulses to cause oscillation of the moving section. Further, it was shown that by adding a fast acting diode across the control coil, the back emf will cause the moving section to move backward a distance farther than without it.

The main differences between the present invention and prior DPLS embodiments by the present inventor are:

### 1. Higher Magnetic Force

The removal of the control coil from the permanent magnet, to form a coil section and a permanent magnet section, produces a stronger magnetic attraction force, between the magnetic core of the coil section and the magnetic core of the permanent magnet section, as the distance to the permanent magnet is reduced by the thickness of the coil. That is, there is less leakage of the magnetic flux from the permanent magnet. As such, the magnetic attraction force is also greater at increase distance to allow the movement distance to be increased for a given magnetic attraction force, which is enhance by the magnetic flux produced in the magnetic core of the coil section by the control coil.

### 2. Use of Magnetic Repulsion

As the control coil is separated from the permanent magnet, magnetic repulsion between the coil section and the permanent magnet section can be used to increase the travel distance, or when two coil sections are used, one can magnetically attract while the other magnetically repels to produce an additive attractive plus repulsive magnetic force.

### 3. Increase Control Length

As the control coil is separated from the permanent magnet, the coil section(s) can be increased in length to accommodate longer control coil(s) having more amp turns to increase the magnetic flux in the magnetic core(s) without increasing the leakage magnetic flux about the permanent magnet, to produce a DPLS or DPLM with increased magnetic attraction or repulsion force at larger distance, which produces a higher additive attractive plus repulsive magnetic force, allowing for increased movement distance.

### 4. Increased Power Output

When used as a DPLM, the increased travel distance allows the springs to reach a given force greater than the magnetic latching force at the surface of the permanent magnet section, to allow high oscillation of the coil section or the permanent magnet section, while preventing magnetic latching. Using two force balanced springs, the stored energy in the springs are transferred during operation to nearly eliminated the spring force on the moving section. Therefore, the overall output power is mainly a function of the magnetic force, between the coil section and the permanent magnet section, times the travel distance, times the oscillation frequency of the moving section.

### BRIEF DESCRIPTION OF THE DRAWINGS

For a better understanding of the present invention, references are made to the accompanying drawings in which:

FIG. 1 shows a cross-sectional view of the two coil section embodiment of the present invention.

FIG. 2 shows the present invention of FIG. 1 in a slide valve.

FIG. 3 shows the present invention of FIG. 1 in a dual acting valve.

FIG. 4 shows the present invention of FIG. 1 in magnetic spring.

FIG. 5 shows the present invention of FIG. 1 in a dual piston compressor or pump.

FIG. 6 shows a one coil section embodiment of the present invention of FIG. 1, where the present invention in FIG. 1 is split through the permanent magnet section to form identical mirrored left (FIG. 6L) and right (FIG. 6R) portions.

FIG. 7 shows right portion (FIG. 6R) of FIG. 6 used as an electromagnetic door holder.

FIG. 8 shows the left portion of FIG. 6L and the right portions of FIG. 6L in a dual piston compressor or pump with moving coil sections.

FIG. 9 shows the left portion of FIG. 6L and the right portions of FIG. 6L in a dual piston compressor with moving magnet sections.

### DETAILED DESCRIPTION OF THE DRAWINGS

Referring to the Drawings as Follows:

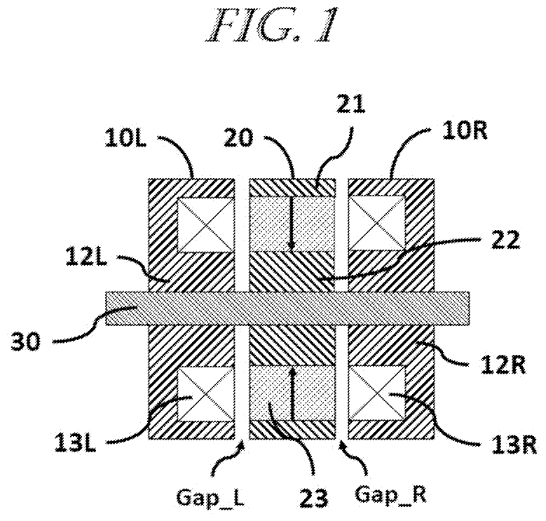

FIG. 1 shows a cross-sectional view of the present invention and constitutes a new embodiment of the Dual Position Latching Solenoid in previous patents by the present inventor, having greater moving distance and greater magnetic force with the same input power than when using the prior art DLPS embodiments of similar size, comprising a permanent magnet section 20, having a first pole side and a second pole side with a separated first coil section 10L on the first pole side and a separated second coil sections 10R on the second pole side, and a pusher 30 through the center of the permanent magnet section 20, the first coil section 10L, and the second coil section 10R, attached to either:

the first coil section 10L and the second coil section 10R, while free to move through the permanent magnetic section 20, to allow movement of the first coil section 10L and the second coil section 10R when the permanent magnetic section 20 is fixed, or

the permanent magnetic section 20, while free to move through the first coil section 10L and the second coil section 10R, to allow movement of the permanent magnetic section 20 when the first coil section 10L and the second coil section 10R are fixed.

In FIG. 1, the gaps (Gap_L and Gap_R) are to illustrate the separation between the two coil sections (10L and 10R) and the permanent magnet section 20.

In FIG. 1, the permanent magnet section 20 is comprised of an outer magnetic core 21 and inner magnetic core 22, encasing on two sides a toroidal or ring permanent magnet 23. The preferred poling of the permanent magnet 23 is north inward (large arrows) toward the inner magnetic core 22. With the preferred poling and without the first coil section 10L and the second coil section 10R present, the magnetic flux from the permanent magnet 23 goes through the inner magnetic core 22 in a first flux direction toward and out the first pole side of the permanent magnet section 20 to and through the outer magnetic core 21 on the first pole side of the permanent magnet section 20 back to the permanent magnet 23, and in a second flux direction toward the second pole side of the permanent magnet section 20 to and through the outer magnetic core 21 on the second pole side of the permanent magnet section 20 back to the permanent magnet 23.

In FIG. 1, the magnetic core 12L encases the control coil 13L on three sides, to produce one pole side with an inner pole, facing the inner magnetic core 22 on the first pole side of the permanent magnet section 20, and an outer pole, facing the outer magnetic core 21 on the first pole side of the permanent magnet section 20, to allow passage of the magnetic flux, from the permanent magnet 23, out of the inner magnetic core 22 on the first pole side of the permanent magnet section 20 to flow into the inner pole of the magnetic core 12L and around the control coil 10L and out the outer pole of the magnetic core 12L, to the outer magnetic core 21 on the first pole side of the permanent magnet section 20 and back to the permanent magnet 23;

In FIG. 1, the magnetic core 12R encases the control coil 13R on three sides, to produce one pole side with an inner pole, facing the inner magnetic core 22 on the second pole side of the permanent magnet section 20, and an outer pole, facing the outer magnetic core 21 on the second pole side of the permanent magnet section 20, to allow passage of the magnetic flux, from the permanent magnet 23, out of the inner magnetic core 22 on the second pole side of the permanent magnet section 20 to flow into the inner pole of the magnetic core 12R and around the control coil 10R and out the outer pole of the magnetic core 12R, to the outer magnetic core 21 on the second pole side of the permanent magnet section 20 and back to the permanent magnet 23.

It is understood that the outer surface area and shape of the inner pole of the magnetic cores (12L and 12R) are, preferred to be, the same as the outer surface area and shape of the inner magnetic core 22 of the permanent magnet section 20, with respect to the first pole side and second pole side.

Further, it is understood that the outer surface area and shape of the outer pole of the magnetic cores (12L and 12R) are, preferred to be, the same as the outer surface area and shape of the outer magnetic core 21 of the permanent magnet section 20, with respect to the first pole side and second pole side.

The present invention in FIG. 1 is operated by a circuit to send an impulse current to the first control coil 13L and the second control coil 13R in a first current direction and second current direction and, preferably, the first control coil 13L and the second control coil 13R are wound:

to cause magnetic attraction between the first coil section 10L and the permanent magnet section 20 or between the second coil section 10R and the permanent magnet section 20 when the impulse current from the circuit is in the first current direction; or

to cause magnetic repulsion between the first coil section 10L and the permanent magnet section 20 or between the second coil section 10R and the permanent magnet section 20 when the impulse current from the circuit is in the second current direction.

It is understood that the present invention is an improved embodiment of the prior art DPLS, in previous patents by the present inventor, to provide increased magnetic force and increase movement distance, due to the control coils (13L and 13R) being separated from the permanent magnet section 20, which reduces leakage magnetic flux about the permanent magnet 23 that would have been present through the control coil(s) 13 in the prior DPLS by the present inventor.

Further, it is understood that the present invention allows the coil sections (10L and 10R) to increase in length to accommodate longer control coils (13L and 13R) having more amp turns to increase the magnetic flux in the magnetic cores (12L and 12R) without increasing the leakage magnetic flux about the permanent magnet 23, to produce a DPLS with increased magnetic attraction or repulsion force at larger separation distance between the coil sections (10L and 10R) and the permanent magnet section 20, which produces even more increased movement distance, which is another improvement over the prior DPLS by the present inventor.

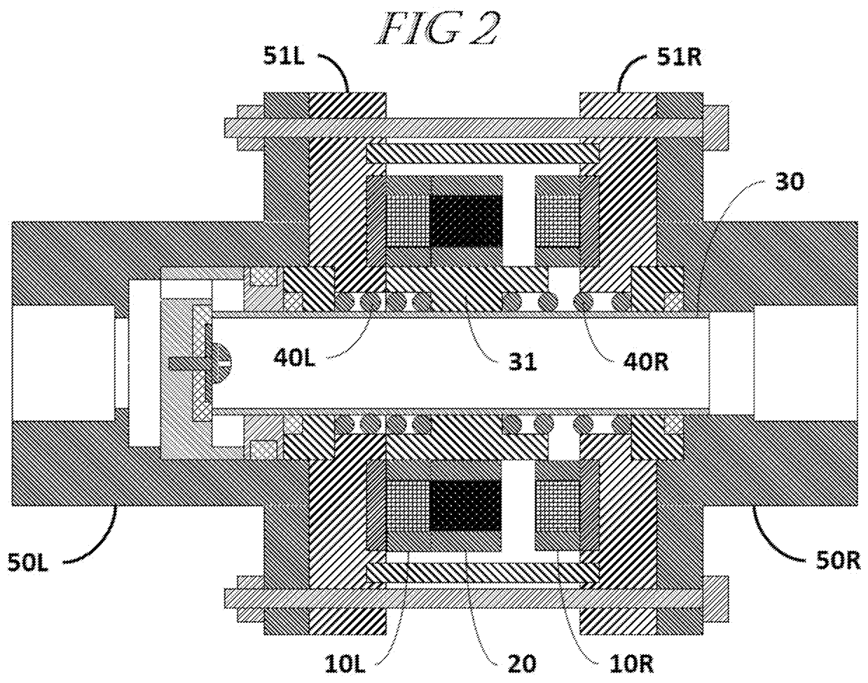

Still further, it is understood that the circuit to operate the present invention is in U.S. Pat. No. 9,343,216, titled “Energy Efficient Bi-Stable Permanent Magnet Actuation System (BSPMAS),” May 17, 2016 by the present inventor, preferably the circuit of FIG. 2 in the patent.

There are three operation modes for the present invention in FIG. 1 as follows.

1. Operation Mode 1

Upon the circuit having sent an impulse current in the first current direction only to the first control coil 13L, to produce a magnetic flux in the first magnet core 12L of the first coil section 10L, to cause the magnetic flux from the permanent magnet 23 in the inner magnetic pole 22 of the permanent magnet section 20 going in the second flux direction toward and out the second pole side of the inner magnetic core 22, to be diverted toward the first pole side of the permanent magnet section 20, adding to the magnetic flux from the permanent magnet 20 in the inner magnetic pole 22 of the permanent magnet section 20 going in the first flux direction toward and out the first pole side of the inner magnetic core 22, toward the first coil section 10L, to increase the magnetic attraction force between the first coil section 10L and the permanent magnet section 20, at the same time, the magnetic attraction force on the second coil section 10R is reduced, with the force on the pusher mainly a function of the magnetic attraction force between the first coil section 10L and the permanent magnet section 20; with the reverse true when the circuit sends an impulse current to only the second control coil 13R in the first current direction.

2. Operation Mode 2

Upon the circuit having sent an impulse current in the second current direction only to the first control coil 13L, to produce a magnetic flux in the first magnet core 12L of the first coil section 12L going toward the first pole of the permanent magnet section 20, to place the first coil section 12L in magnetic repulsion with the permanent magnet section 20, at the same time, the magnetic attraction force on the second coil section 12R is increased, with the force on the pusher mainly a function of the magnetic repulsion force between the first coil section 12L and the permanent magnet section 20 and the attraction force between the second coil section 12R and the permanent magnet section 20; with the reverse true when the circuit sends an impulse current to only the second control coil 13R in the second current direction;

3. Operation Mode 3

Upon the circuit having sent an impulse current to the first control coil 13L in the first current direction and the second control coil 13R in the second current direction, to produce a magnetic flux in the first magnet core 12L of the first coil section 10L as described in Operation Mode 1, placing the first coil section 10L and the permanent magnet section 20 in magnetic attraction, and in the second magnet core 12R of the second coil section 10R, as described in Operation Mode 2, placing the second coil section 10R and the permanent magnet section 20 in magnetic repulsion, whereby the force on the pusher 30 is a function of the magnetic attraction force on the first coil section 10L plus the magnetic repulsion force on the second coil section 10R; with the reverse true when the circuit has sent an impulse current to the first control coil 13L in the second current direction and the second control coil 13L in the first current direction.

It is understood that the present invention in FIG. 1 can replace the DPLS in the prior art inventions by the present inventor and provide new uses due to the increased movement distance and magnetic attraction force. As example:

### 1. Slide Valve

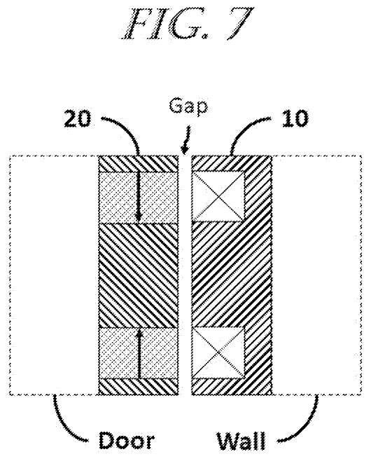

FIG. 2 is FIG. 7 of U.S. Pat. No. 9,702,477, Jul. 11, 2017 by the present inventor, wherein the present invention of FIG. 1 replaces the previous DPLS in the slide valve. In FIG. 2, the present invention of FIG. 1 comprising the coil sections (10L and 10R), permanent magnet section 20 and pusher (tube) 30 are placed between the valve body (50L and 50R), with the coil sections (10L and 10 R) attached to the valve body parts (51L and 51R), and with the permanent magnet section 20 attached to tube attachment 31, attached to the (pusher) tube 30.

In FIG. 2 with reference to FIG. 1, tube 30 is in the first latching position with the permanent magnet section 20 magnetically latched against the coil section 10L, where when the control coils (13L and 13R) in FIG. 1 are sent an impulse current, with respect to Operation Modes 1-3, Operation Mode 3 being preferred, the tube 30 will move to the second latching position with the permanent magnet section 20 magnetically latched against the coil section 10R, with the movement of the tube 30 aided by the springs (40L and 40R) as discussed in U.S. Pat. No. 9,702,477. Reversal of the impulse current to both control coils (13L and 13R) in FIG. 1, with respect to Operation Modes 1-3, Operation Mode 3 being preferred, will return the permanent magnet section 20 and tube 30 to the first latching position.

It is understood that since the present invention of FIG. 1 will provide greater moving distance and greater magnetic force with the same input power than when using the previous DLPS embodiment in U.S. Pat. No. 9,702,477 of similar size, the tube 30 in the slide valve of FIG. 2, can be larger to provide greater flow volume with improved efficiency or the present invention can be smaller to provide the same force at the current tube 30 size with improved efficiency.

### 2. Dual Acting Valve

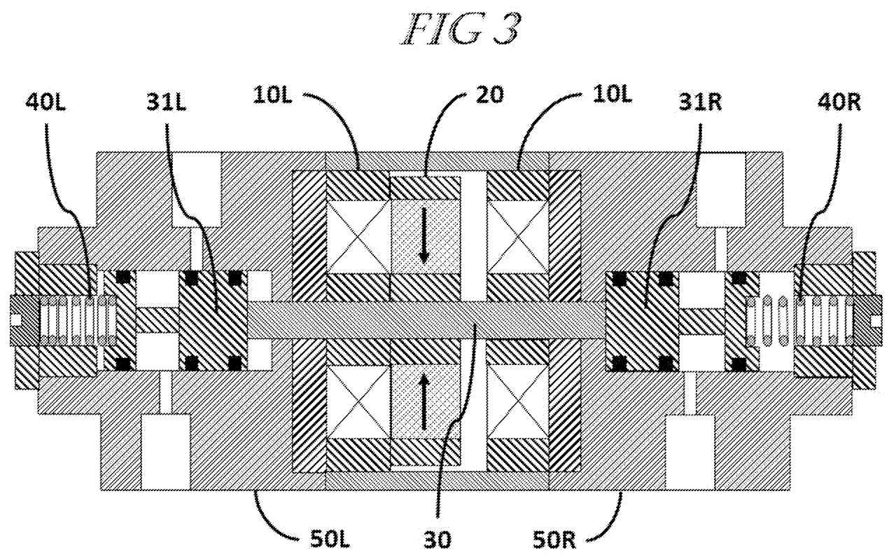

FIG. 3 is FIG. 1 of U.S. Pat. No. 10,024,453, Jul. 17, 2018 by the present inventor, wherein the present invention of FIG. 1 replaces the previous DPLS in a Dual Acting Valve. In FIG. 3, the present invention of FIG. 1 comprising the coil sections (10L and 10 R), permanent magnet section 20 and pusher 30 are placed between the valve body (50L and 50R), with the coil sections (10L and 10R) attached to the valve body (50L and 50R) and with the permanent magnet section 20 attached to the pusher 30 to move poppets (31L and 31R) against springs (40L and 40R).

In FIG. 3 with reference to FIG. 1, pusher 30 and poppets (31L and 31R) are in the first latching position with the permanent magnet section 20 magnetically latched against the coil section 10L, where when the control coils (13L and 13R) in FIG. 1 are sent an impulse current to both control coils (13L and 13R), with respect to Operation Modes 1-3, Operation Mode 3 being preferred, the pusher 30 will move to the second latching position with the permanent magnet section 20 magnetically latched against the coil section 10R, with the movement of the pusher 30 and poppets (31L and 31R) aided by the spring 40L as discussed in U.S. Pat. No. 9,702,477. Reversal of the impulse current to both control coils (13L and 13R) in FIG. 1, with respect to Operation Modes 1-3, Operation Mode 3 being preferred, will return the permanent magnet section 20 and pusher 30 and poppets (31L and 31R) aided by the spring 40R to the first latching position of FIG. 3.

It is understood that since the present invention of FIG. 1 will provide greater moving distance and greater magnetic force with the same input power than when using the previous DLPS embodiment in U.S. Pat. No. 9,702,477 of similar size, the present invention will be smaller when providing the same force and movement distance to the poppets (31L and 31R), thus having improved efficiency.

### 3. Magnetic Spring

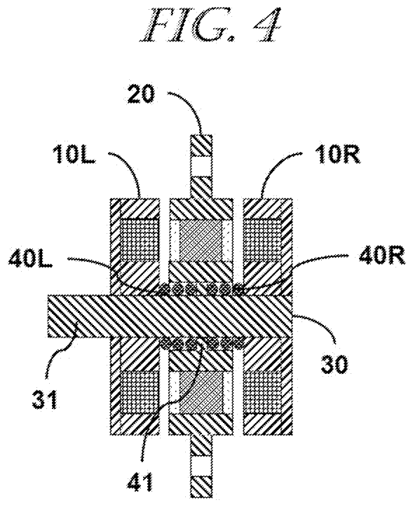

FIG. 4 is a combination of FIGS. 2 and 3b of U.S. Pat. No. 10,236,109, Mar. 19, 2019 by the present inventor, wherein the present invention of FIG. 1 replaces the previous DPLS in a Magnetic Spring. In FIG. 4 with reference to FIG. 1, springs (40L and 40R) and spring stop 41 are added to the present invention of FIG. 1, comprising the coil sections (10L and 10R), permanent magnet section 20 and pusher 30, with the spring stop 41 attached to the inner magnetic core 22 in FIG. 1 of the permanent magnet section 20, where the pusher 30 is attached to the coil sections (10L and 10R) and free to move through the spring stop 41.

In FIG. 4, the coil sections (10L and 10R) are prevented from latching by the springs (40L and 40R), while allows movement of the coil sections (10L and 10R), the permanent magnet section 20 is attached to a first structure and the protruding end 31 of the pusher 30 is used to attach the coil sections (10L and 10R) to a second structure, to dampen vibration of the second structure, as described in U.S. Pat. No. 10,236,109.

In FIG. 4 with reference to FIG. 1, the control coils (13L and 13R) in FIG. 1 are sent current impulses, with respect to Operation Modes 1-3, to change the magnetic attraction or repulsion between the coil sections (10L and 10R) and permanent magnet section 20 to dampen vibrations on either the first or second structure, as described in U.S. Pat. No. 10,236,109.

It is understood that since the present invention of FIG. 1 will provide greater magnetic force with the same input power than when using the previous DLPS embodiment in U.S. Pat. No. 10,236,109 of similar size, the present invention will be smaller when providing the same dampening force to coil sections (10L and 10R), thus having improved efficiency.

Further, it is understood that the increased movement distance and magnetic attraction force, in the present invention allows the present invention to be operated by high frequency impulse currents to the control coils (13L and 13R), thus allowing higher dynamic isolation.

### 4. Linear Motor

The increased movement distance and magnetic attraction force, allows the present invention to be used as a linear motor with high frequency impulse currents to the control coils (13L and 13R), referred to herein as a Dual Poled Linear Motor (DPLM).

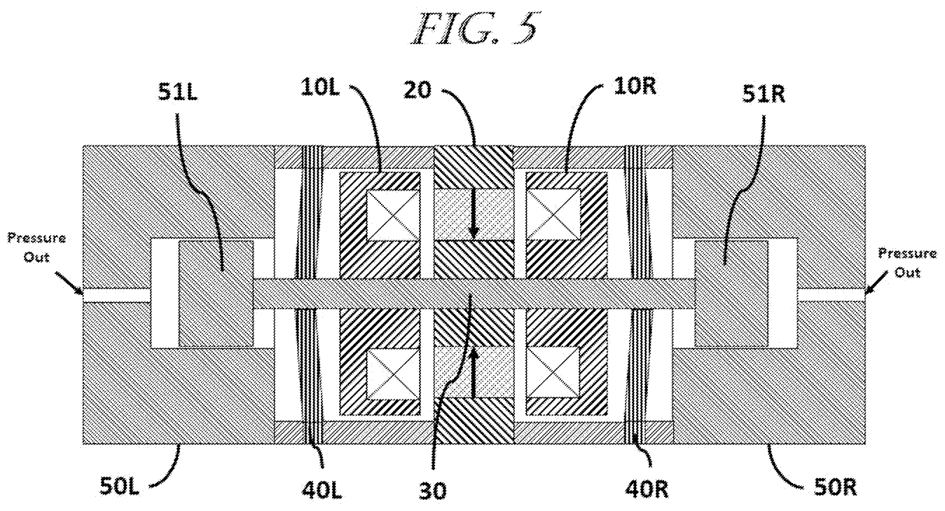

FIG. 5 illustrates the present invention of FIG. 1 as a Dual Poled Linear Motor (DPLM) in a dual piston compressor or pump, comprising the coil sections (10L and 10R), the permanent magnet section 20, the pusher 30, flexure springs (40L and 40R), pistons (51L and 51R), and housing blocks (50L and 50R). In FIG. 5, the pusher 30 is attached to the coil sections (10L and 10R), the flexure springs (40L and 40R), and the pistons (51L and 51R), but free to move through permanent magnet section 20. In FIG. 5, the permanent magnet section 20 and the outer portion of the flexure springs (40L and 40R) are attached to the housing blocks (50L and 50R).

It is understood that the coil sections (10L and 10R) could be fixed to the housing blocks (50L and 50R) and the permanent magnet section 20 free to move, with the pusher 30 attached to the permanent magnet section 20 and free to move through the coil sections (10L and 10R).

In FIG. 5, the flexure springs (40L and 40R) provide a balance counter force to the magnet force cause by the magnetic flux from the permanent magnet 23 emanating out both sides (poles) of the permanent magnet section 20 to prevent magnetic latching of the coil sections (10L and 10R).

Operation of the present invention as a DPLM in the dual piston compressor or pump in FIG. 5 is the same as for FIG. 1, preferably Operation Mode 3, except the impulse current is sent to one or both control coils (13L or 13R) at a desired frequency, to cause a sinusoidal oscillation of the coil sections (10L or 10R), aided by the oscillations of the flexure springs (40L and 40R). The same circuit used for the present invention in FIG. 1 is preferred, with the controller sending out the impulse at the desired frequency of operation. Further, due to the faster oscillation of the coil sections (10L or 10R), a fast acting diode is recommended, placed across the control coils (13L and 13R) for back emf protection. Further, tests have shown that the back emf through the diode back to the control coils (13L and 13R) causes an increase to the travel distance.

It is understood that the output pressure of the compressor or pump of FIG. 5 will be a function of the net (minus losses) magnetic force between a coil sections (10L and 10R) and the permanent magnet section 20, and the area of the piston (51L or 51R), when the flexure springs (40L and 40R) are in a balanced mode, adding or subtracting the spring force between them.

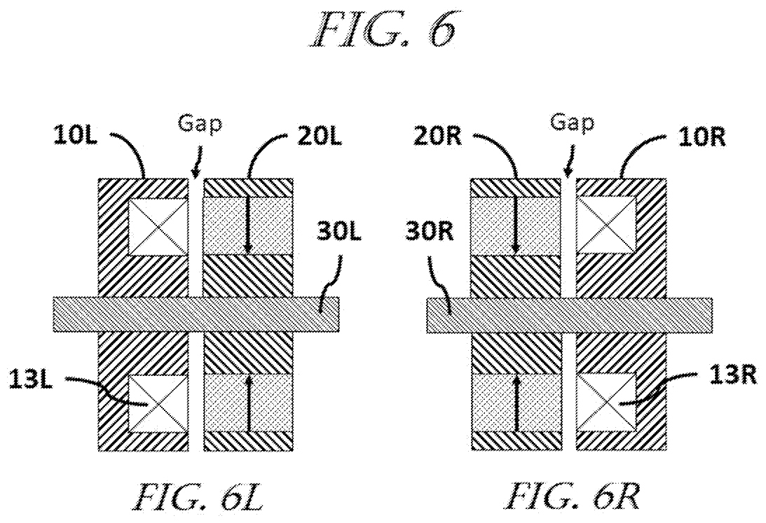

FIG. 6 shows FIG. 1 with the permanent magnet section 20 divided into two identical left section in FIG. 6L and right section in FIG. 6R. Each section, FIG. 6L or FIG. 6R, comprises one coil section (10L or 10R), a permanent magnet section (20L or 20R), and a pusher (30L or 30R). Operation of the each section, (FIG. 6L or FIG. 6R), would be in respect to Operation Mode 1-2 for FIG. 1 with just one control coil (13L or 13R).

It is understood that one section (FIG. 6L or FIG. 6R) could replace the DPLS in the slide valve of FIG. 2, could operate one of the valves in FIG. 3, and possible be used in a version of the magnetic spring in FIG. 4.

FIG. 7 is the door holder unit and plate fixture in FIG. 1 of U.S. Pat. No. 10,508,481, Dec. 17, by the present inventor, wherein a coil section (10L or 10R) of the present invention of FIG. 6 replaces the previous DPLS portion 1 (BS-EPM) or portion 2 (2EPM-EPM) attached to the Wall, and permanent magnet section (20L or 20R) of the present invention of FIG. 6 replaces the previous DPLS portion 18 (attractive plate) attached to the Door. Operation of the present invention in FIG. 7 is the much the same as described U.S. Pat. No. 10,508,481 with the portion replacements as described and the impulse current directed to cause magnetic repulsion between the permanent magnet section 10 and the coil section 20, with respect to Operation Mode 2 for FIG. 1, and with one control coil (13L or 13R).

It is understood that the advantage of using the present invention of FIG. 7 over the DPLS in U.S. Pat. No. 10,508,481 will be a reduction in size for a given magnetic holding force, which will reduce the magnet material and reduce the power input, as the coil section (20L or 20R) will be smaller, and the use of magnetic repulsion to help push the Door away from the permanent magnet section (20L or 20R).

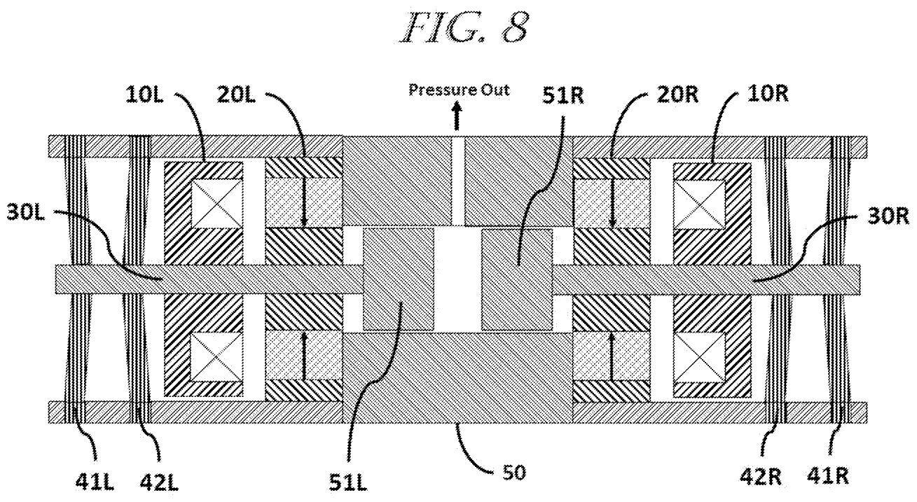

FIG. 8 shows the split DPLS of FIG. 6 used as a moving coil, Dual Poled Linear Motor (DPLM) in a dual piston compressor or pump, comprising coil sections (10L and 10R), permanent magnet sections (20L and 20R), pushers (30L and 30R), flexure spring pairs (41L, 41L) and (41R, 42R), pistons (51L and 51R), and housing block 50. In FIG. 8, the permanent magnet sections (20L and 20R) are attached on either side of the housing block 50, the pushers (30L and 30R) are attached to their respective pistons (51L or 51R), coil sections (10L or 10R), and flexure spring pairs (41L, 41L) or (41R, 42R), and free to move through their respective permanent magnet sections (20L or 20R). Further, in FIG. 8, the outer portions of the flexure spring pairs (41L, 41L) and (41R, 42R) are attached to the housing block 50.

In FIG. 8, the flexure spring pairs (41L, 41L) and (41R, 42R) provide a balance counter force to the magnetic force cause by the magnetic flux from their respective permanent magnet sections (20L or 20R), to prevent magnetic latching of their respective coil sections (10L or 10R) and sets the spacing (gap) between their respective permanent magnet sections (20L or 20R) and coil sections (10L or 10R).

The DPLM in FIG. 8, with reference to FIG. 6, are preferably operated simultaneously, with the impulse current going to the control coils (13L and 13R) of FIG. 6 in coil sections (10L and 10R) at the same time, using the respective Operation Modes 1 or 2 for FIG. 1 for one control coils (13L and 13R), to cause the pistons (51L and 51R) to move toward or away from each other in opposite direction at the same time.

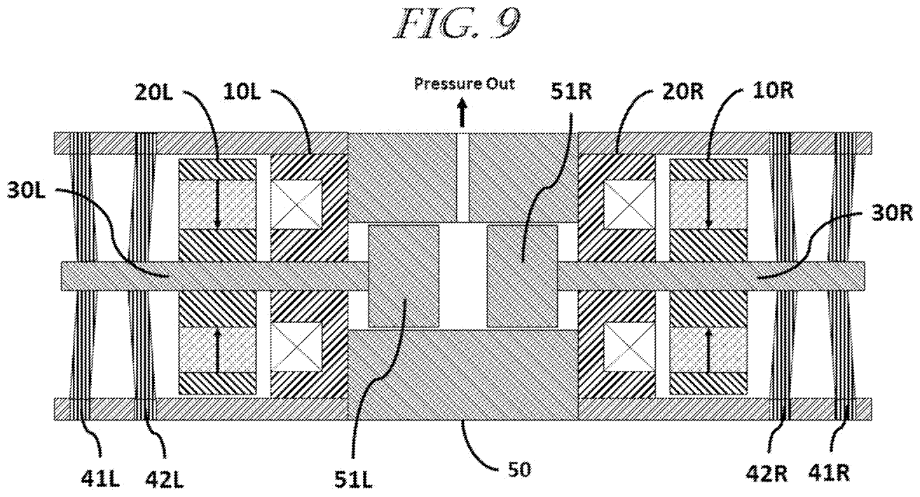

FIG. 9 shows the split DPLS of FIG. 6 used as a moving permanent magnet, Dual Poled Linear Motor (DPLM) in a dual piston compressor or pump, comprising coil sections (10L and 10R), permanent magnet sections (20L and 20R), pushers (30L and 30R), flexure spring pairs (41L, 41L) and (41R, 42R), pistons (51L and 51R), and housing block 50. In FIG. 9, the coil sections (10L and 10R) are attached on either side of the housing block 50, the pushers (30L and 30R) are attached to their respective pistons (51L or 51R), permanent magnet sections (20L or 20R), and flexure spring pairs (41L, 41L) or (41R, 42R), and free to move through their respective coil sections (10L or 10R). Further, in FIG. 9, the outer portions of the flexure spring pairs (41L, 41L) and (41R, 42R) are attached to the housing block 50.

In FIG. 9, the flexure spring pairs (41L, 41L) and (41R, 42R) provide a balance counter force to the magnetic force cause by the magnetic flux from their respective permanent magnet sections (20L or 20R), to prevent magnetic latching of their respective coil sections (10L or 10R) and sets the spacing (gap) between their respective permanent magnet sections (20L or 20R) and coil sections (10L or 10R).

The DPLM in FIG. 9, with reference to FIG. 6, are preferably operated simultaneously, with the impulse current going to the control coils (13L and 13R) of FIG. 6 in coil sections (10L and 10R) at the same time, using the respective Operation Modes 1 or 2 for FIG. 1 for one control coils (13L and 13R), to cause the pistons (51L and 51R) to move toward or away from each other in opposite direction at the same time.

It is understood that the DPLMs in FIG. 5, 8 or 9, could be single linear motor compressors or pumps using the left (FIG. 6L) or right (FIG. 6L) portion of the present invention in FIG. 6.

It is also understood that most compressors and all pumps will have an inlet port (not shown in FIG. 5, 8 or 9) for the gas or liquid that is being compressed or pumped.

What is claimed is:

1. A Dual Position Latching Solenoid (DPLS) having two coils separated from the permanent magnet to produce an increased magnetic force and allow greater motion distance, and with a moving coil section or moving permanent magnet section for various magnetic latching and linear motor applications, comprising:
a permanent magnet section having a first pole side and second pole side comprising,
an outer magnetic core having a pole on both said first pole side and said second pole side; an inner magnetic core having a pole on both said first pole side and said second pole side; and
a toroidal or ring permanent magnet encased between said outer magnetic core and said inner magnetic core, poled from said outer magnetic core to said inner magnetic core, where the magnetic flux from said permanent magnet goes through said inner magnetic core in a first flux direction toward and out said first pole side and a second flux direction toward and out said second pole side, returning through said first pole side and said second pole side of said outer magnetic core back to said permanent magnet;
a first coil section, having only one pole side, facing said first pole side of said permanent magnet section, comprising;
a first control coil; and
a first magnetic core with said one pole side, encasing said first control coil on three sides, forming:
an inner pole, facing said inner magnetic core on said first pole side of said permanent magnet section, and
an outer pole, facing said outer magnetic core on said first pole side of said permanent magnet section,
to allow passage of the magnetic flux from said permanent magnet out of said inner magnetic core on said first pole side of said permanent magnet section to flow into said inner pole of said first magnetic core and around said first control coil and out said outer pole of said first magnetic core, to said outer magnetic core on said first pole side of said permanent magnet section and back to said permanent magnet;
a second coil section, having only one pole side facing said second pole side of said permanent magnet section comprising;
a second control coil; and
a second magnetic core with said one pole side, encasing said second control coil on three sides, forming:
an inner pole, facing said inner magnetic core on said second pole side of said permanent magnet section, and
an outer pole, facing said outer magnetic core on said second pole side of said permanent magnet section,
to allow passage of the magnetic flux from said permanent magnet out of said inner magnetic core on said second pole side of said permanent magnet section to flow into said inner pole of said second magnetic core and around said second control coil and out said outer pole of said second magnetic core, to said outer magnetic core on said second pole side of said permanent magnet section and back to said permanent magnet;
a pusher through the center of said permanent magnet section, said first coil section, and said second coil section, either attached to:
said first coil section and said second coil section, while free to move through said permanent magnetic section, to allow movement of said first coil section and said second coil section when said permanent magnetic section is fixed, or
said permanent magnetic section, while free to move through said first coil section and said second coil section, to allow movement of said permanent magnetic section when said first coil section and said second coil section are fixed; and
a circuit to send an impulse current to said first control coil and said second control coil in a first current direction and second current direction,
wherein said first control coil and said second control coil are wound to cause
an attraction between said first coil section and said permanent magnet section or between said second coil section and said permanent magnet section when said impulse current from said circuit is in said first current direction, or
a repulsion between said first coil section and said permanent magnet section or between said second coil section and said permanent magnet section when said impulse current from said circuit is in said second current direction;
wherein upon said circuit having sent said impulse current in said first current direction only to said first control coil, to produce a magnetic flux in said first magnet core of said first coil section, to cause the magnetic flux from said permanent magnet in said inner magnetic pole of said permanent magnet section going in said second flux direction toward and out said second pole side of said inner magnetic core, to be diverted toward said first pole side of said permanent magnet section, adding to the magnetic flux from said permanent magnet in said inner magnetic pole of said permanent magnet section going in said first flux direction toward and out said first pole side of said inner magnetic core, toward said first coil section, to increase the magnetic attraction force between said first coil section and said permanent magnet section, at the same time, the magnetic attraction force on said second coil section is reduced, with the force on said pusher mainly a function of the magnetic attraction force between said first coil section and said permanent magnet section; with the reverse true when said circuit sends said impulse current to only said second control coil in said first current direction;
wherein upon said circuit having sent said impulse current in said second current direction only to said first control coil, to produce a magnetic flux in said first magnet core of said first coil section going toward said first pole of said permanent magnet section, to place the first coil section in magnetic repulsion with said permanent magnet section, at the same time, the magnetic attraction force on said second coil section is increased, with the force on said pusher mainly a function of the magnetic repulsion force between said first coil section and said permanent magnet section and the attraction force between said second coil section and said permanent magnet section; with the reverse true when said circuit sends said impulse current to only said second control coil in said second current direction;
wherein upon said circuit having sent said impulse current to said first control coil in said first current direction and said second control coil in said second current direction, to produce a magnetic flux in:
said first magnet core of said first coil section, to cause the magnetic flux from said permanent magnet in said inner magnetic core of said permanent magnet section going toward said second pole side of said permanent magnet section, to be diverted toward said first pole side of said permanent magnet section, adding to the magnetic flux from said permanent magnet in said inner magnetic pole of said permanent magnet section going in said first flux direction toward and out said first pole side of said inner magnetic core, toward said first coil section, to increase the magnetic attraction force between said first coil section and said permanent magnet section, and
said second magnet core of said second coil section, to produce a magnetic flux in said second magnet core of said second coil section going toward said second pole of said permanent magnet section, to place the second coil section in magnetic repulsion with said permanent magnet section,
whereby the force on said pusher is a function of the magnetic attraction force on said first coil section plus the magnetic repulsion force on said second coil section; with the reverse true when said circuit has sent said impulse current to said first control coil in said second current direction and said second control coil in said first current direction;
to produce a DPLS for various magnetic latching and linear motor applications.

2. The DPLS of claim 1 used in a valve.

3. The DPLS of claim 1 used in a magnetic spring.

4. The DPLS of claim 1 wherein the first control coil and second control coil are composed of multiple coils in parallel to reduce the resistance of said first control coil and said second control coil.

5. The DPLS of claim 1, wherein the circuit is a BSPMAS.

6. The DPLS of claim 1, used as a Dual Poled Linear Motor (DPLM) for various linear motor applications, having:
a first spring and second spring attached to the pusher to prevent magnetic latching, force balanced with the spring forces, between the first spring and the second spring, and with magnetic force, between the permanent magnet section and the first coil section and the second coil section, to maintain a separation between said permanent magnet section and said first coil section and second coil section; and
where when the circuit sends high frequency impulse currents in the first current direction or the second current direction to said first coil section and said second coil section to cause:
said first coil section and said second coil section to oscillate repeatedly, when said permanent magnet section is fixed, or
said moving permanent magnet section to oscillate repeatedly, when said first coil section and said second coil section are fixed,
to produce a Dual Poled Linear Motor (DPLM) for various linear motor applications.

7. The DPLS of claim 1, where a diode is placed across the first control coil and second control coil;

8. The DPLS of claim 1 used in a compressor with the pusher attached to at least one compressor piston.

9. The DPLS of claim 1 used in a pump with the pusher attached to at least one pump piston.

10. A Dual Position Latching Solenoid (DPLS) having one coil separated from the permanent magnet to produce an increased magnetic force and allow greater motion distance, and with a moving coil section or moving permanent magnet section for various magnetic latching and linear motor applications, comprising:
a permanent magnet section having a first pole side and second pole side comprising,
an outer magnetic core having a pole on both said first pole side and said second pole side;
an inner magnetic core having a pole on both said first pole side and said second pole side; and
a toroidal or ring permanent magnet encased between said outer magnetic core and said inner magnetic core, poled from said outer magnetic core to said inner magnetic core, where the magnetic flux from said permanent magnet goes through said inner magnetic core in a first flux direction toward and out said first pole side and a second flux direction toward and out said second pole side, returning through said first pole side and said second pole side of said outer magnetic core back to said permanent magnet; and
a coil section, having only one pole side facing said first pole side of said permanent magnet section comprising;
a control coil; and
a magnetic core with said one pole side, encasing said first control coil on three sides, forming:
an inner pole, facing said inner magnetic core on said first pole side of said permanent magnet section, and
an outer pole, facing said outer magnetic core on said first pole side of said permanent magnet section,
to allow passage of the magnetic flux from said permanent magnet out of said inner magnetic core on said first pole side of said permanent magnet section to flow into said inner pole of said first magnetic core and around said first control coil and out said outer pole of said first magnetic core, to said outer magnetic core on said first pole side of said permanent magnet section and back to said permanent magnet;
a pusher through the center of said permanent magnet section and said coil section, either attached to:
said coil section and free to move through said permanent magnetic section, to allow movement of said coil section when said permanent magnetic section is fixed, or
said permanent magnetic section and free to move through said coil section, to allow movement of said permanent magnetic section when the coil section is fixed; and
a circuit to send an impulse current to said control coil in a first current direction and second current direction,
wherein said control coil is wound to cause
an attraction between said coil section and said permanent magnet section when said impulse current from said circuit is in said first current direction, or
a repulsion between said coil section and said permanent magnet section when said impulse current from said circuit is in said second current direction;
wherein said coil section is on the first side of said permanent magnet section and upon said circuit having sent said impulse current in said first current direction to said control coil, to produce a magnetic flux in said magnet core of said coil section, to cause the magnetic flux from said permanent magnet in said inner magnetic pole of said permanent magnet section going in said second flux direction toward and out said second pole side of said inner magnetic core, to be diverted toward said first pole side of said permanent magnet section, adding to the magnetic flux from said permanent magnet in said inner magnetic pole of said permanent magnet section going in said first flux direction toward and out said first pole side of said inner magnetic core, toward said coil section, to increase the magnetic attraction force between said coil section and said permanent magnet section, where when said pusher is attached to:
said coil section with the permanent magnet section fixed, where said coil section is allowed to move toward said permanent magnet section, or
said permanent magnetic section with the coil section fixed, where said permanent magnetic section is allowed to move toward said coil section;
to produce a DPLS, having one control coil, and a moving coil section or moving permanent magnet section, for various magnetic latching and linear motor applications.

11. The DPLS of claim 10 used in a valve.

12. The DPLS of claim 10 wherein the control coil is composed of multiple coils in parallel to reduce the resistance of said control coil.

13. The DPLS of claim 10, wherein the circuit is a BSPMAS.

14. The DPLS of claim 10, used as a Dual Poled Linear Motor (DPLM) for various linear motor applications, having:
a first spring and second spring are attached to the pusher to prevent magnetic latching, force balanced with the spring forces, between the first spring and the second spring, and with magnetic force, between the coil section and the permanent magnet section, to maintain a separation between said coil section and said permanent magnet section; and
where when, the circuit sends high frequency impulse currents in said first current direction or second current direction to the control coil to cause
said coil section to oscillate repeatedly, when said permanent magnet section is fixed, or
said permanent magnet section to oscillate repeatedly, when said coil section is fixed to produce a Dual Poled Linear Motor (DPLM) for various linear motor applications.

15. The DPLS of claim 10, where a diode is placed across the control coil to allow passage of the back emf current into said control coil;

16. The DPLS of claim 10 used in a compressor with the pusher attached to at least one compressor piston.

17. The DPLS of claim 10 used in a pump with the pusher attached to at least one pump piston.
